(19) United States
(12) Patent Application Publication
(10) Pub. No.: US 2008/0168109 A1
(43) Pub. Date: Jul. 10, 2008

(54) AUTOMATIC MAP UPDATING BASED ON SCHEMA CHANGES

(75) Inventors: Suraj Gaurav, Issaquah, WA (US); Surendra Machiraju, Issaquah, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/621,372

(22) Filed: Jan. 9, 2007

(51) Int. Cl. G06F 17/30

(52) U.S. Cl. 707/203; 707/E17.005

(57) ABSTRACT

Systems and methods for automatic updating of maps based on changes to underlying schema is provided. Schema maps are automatically updated based on changes in underlying schema, such as TSDs of an EDI system. A versioning mechanism also versions the schema maps as they evolve over time, so that changes in the schema maps can be understood commensurate with the changes in the underlying schema. A tool is also provided that allows a user to interface with different versions of schema maps and underlying schema, enabling a visual understanding to understand the evolution of any schema map and the underlying schema. Moreover, the tool allows manual changes to the underlying schema, which in turn results in automatic updating of the affected map(s).

### TECHNICAL FIELD

The subject disclosure relates to automatic updating of schema map(s) in a computing system in response to changes affecting one or more schema upon which the schema map(s) depend.

### BACKGROUND

Electronic Data Interchange (EDI) has empowered organizations to send virtually limitless kinds of structured messages to one another to facilitate the communication of any kind of business data from one organization to another in automated ways. Once an EDI system is setup properly, EDI messages can be used to automate a variety of communications to and from partners, business sub-units, sellers, buyers, etc., thereby substantially reducing the overhead associated with filling out paper forms, storing volumes of papers, etc. With EDI, for instance, an organization merely fills out an electronic form, which creates an EDI document in a manner conforming to a pre-defined schema, and then the messaging, storage/record keeping and validation of the message(s) associated with the electronic form occurs automatically.

EDI messages thus have an associated EDI schema, also called a transaction set definition (TSD), which instructs an EDI system how to interpret a given EDI message instance, i.e., how to validate an EDI message has been structured correctly and with appropriate information. In this regard, there are thousands of EDI message types. For instance, when an EDI message of a particular type, e.g., a purchase order, is created by an EDI system, the EDI message is created in a way that conforms to the purchase order schema.

Today, any of extensible markup language (XML) Schema Definitions (XSDs), external data representations (XDRs), document type definitions (DTDs) or rules in a database are used to represent schemas for EDI messages. In this regard, XSDs, XDRs, DTDs and rules in a database are schema files that can be created to describe the schema for a particular kind of EDI message. Today, these XSD, XDR and DTD files are stored as individual files that are used in connection with the validation and generation of EDI messages in an EDI system.

When an organization is maximizing the value of EDI messaging, the organization might be storing countless schemas on behalf of the EDI system, and even numerous versions of the same schema, which are constantly evolving as business practices change, etc. Additionally, at any given time, business processes might be simultaneously taking advantage of the benefits of an EDI system by storing and using numerous schema maps, which describe relationships between schema and thus provide a roadmap for translating, or converting, document(s) adhering to one schema to document(s) adhering to another. For instance, a simple example of an EDI application is receiving an EDI document, validating that it conforms to an associated EDI schema, and then storing the EDI document.

However, oftentimes, complex operations are spawned as a result of receiving the EDI document as well. For instance, a purchase order received by an EDI system might simultaneously cause the generation, transmission and/or storage of a third party order request document, an invoice document, a receipt document, a record keeping document, etc. In most cases, the generation of these documents is efficiently performed by consulting schema maps that explain to the EDI system how to transform one or more items of information based on, e.g., a purchase order schema to one or more items of information based on different schema for the various documents to be created. One way to create these documents in an EDI system is thus to consult maps that provide conversion mappings among schema types. Accordingly, maps instruct an EDI system how to transform a first document instance adhering to a first schema to a second document instance adhering to a second schema.

The notion of maps is generally illustrated in FIG. 16, showing an EDI system that includes various schemas 1610 stored in data stores 1630a to 1630n and various maps 1600 stored in data stores 1640a, 1640b, . . . 1640n. Maps 1600 serve to translate among various schemas of data stores 1630a to 1630n in order to facilitate conversion between the various schemas in connection with one or more processes of the EDI system. For instance, map 1600a operates to convert between a first schema 1610a and a second schema 1610b.

As shown for illustrative purposes, schema 1610a includes node elements C1, C2 and C3 at a first hierarchical level, and node C2 includes two sub-nodes F1 and F2. The relationships and rules that apply to node elements C1, C2, C3, F1 and F2 define the structure of schema 1610a and for a document to be valid according to schema 1610a, the document must adhere to such structure (except for any optional structure).

In a similar vein, schema 1610b includes node elements F1′, F2′ and C1′ at a first hierarchical level, and C2′ is a sub-node of C1′. Pertinent information of map 1600a includes the conceptual arrows between the nodes and sub-nodes, which show how to transform a document adhering to schema 1610a to a document adhering to schema 1610b. For instance, the element C1 of schema 1610a maps to element C1′ of schema 1610b, and so on.

Once the number of schemas and schema maps starts to exceed a few dozen, however, updating the schema maps when the underlying schema upon which they are predicated changes is a huge problem. Today, when a schema changes in an EDI system, a system administrator must also manually change any maps that are also affected by any change in underlying schema.

This is difficult for the system administrator for a variety of reasons. Analyzing differences in schema and then translating the differences to affected maps is difficult because it requires a thorough ability to read and understand schema in order for the system administrator to distill the formatting information from the schema elements. For an EDI system, for instance, this is error prone because a user can never be sure all changes have been observed from a manual review. In addition, if the changes from version to version become numerous or involve complex structural changes, line by line comparisons are too slow and complex to cover all of the maps that must be updated in a timely, error-free or resource-efficient manner.

In addition, the sheer number of maps in a system may be prohibitive, i.e., one person cannot change thousands of maps in a timely manner. Even where there are only hundreds of schema, there may be thousands of schema maps that depend on those hundreds of schema, and so a change to a single schema may impact dozen(s) of schema maps depending on the complexity of the business processes involved.

The issues compound when both EDI schemas and schema maps are considered because today users are expected to create schema based on Implementation Guides (a.k.a. Companion Guides, i.e., PDF or DOC documents) that explain verbally and/or pictorially how users are expected to define TSDs (EDI schema) for computer based validation. Common formats for such TSDs are DTD or XSD or rules in a database. In this regard, the schemas can be used in several extensible stylesheet language transformation (XSLT) based map files to transform EDI documents from one format to another. Over a period of time, the schemas can change, thus making the maps invalid. In addition, as mentioned, the same schema can be used in multiple maps, thus exacerbating the problem. Accordingly, what is needed is a mechanism that allows maps to be automatically updated based on the schema changes. Moreover, it would be desirable to have a mechanism to version the maps as they evolve so that a user can understand changes to a map as it evolves over time.

Yet another problem arises when an organization that is using a first EDI system desires to switch, or migrate, to a second EDI system different from the first, e.g., due to wide sweeping changes in system requirements. It would be desirable to be able to migrate the numerous maps and schema that were created on the first EDI system to the second EDI system, but today, this must be done by hand, i.e., a user must recreate each of the maps for use with the second EDI system, a painstaking and tedious process.

Accordingly, in consideration of the lack of sophistication of the current state of the art of updating maps when underlying elements of a schema change in an EDI communications system, it would be desirable to provide automatic updating of maps when one or more schema represented by the maps change. These and other deficiencies in the state of the art of EDI systems will become apparent upon description of the various exemplary non-limiting embodiments of the invention set forth in more detail below.

### SUMMARY

In consideration of the foregoing, the invention provides automatic updating of maps based on changes in underlying schema. In various non-limiting embodiments implemented in the non-limiting context of EDI systems, the invention provides automatic updating of EDI schema maps based on changes in underlying EDI schema, e.g., TSDs. A versioning mechanism also versions the schema maps as they evolve over time, so that changes in the schema maps can be understood commensurate with the changes in the underlying schema.

A tool is also provided that allows a user to interface with different versions of schema maps and underlying schema, enabling a visual understanding to understand the evolution of any schema map and the underlying schema. Moreover, the tool allows manual changes to the underlying schema, which in turn results in automatic updating of the affected map(s).

A simplified summary is provided herein to help enable a basic or general understanding of various aspects of exemplary, non-limiting embodiments that follow in the more detailed description and the accompanying drawings. This summary is not intended, however, as an extensive or exhaustive overview. The sole purpose of this summary is to present some concepts related to the various exemplary non-limiting embodiments of the invention in a simplified form as a prelude to the more detailed description that follows.

### BRIEF DESCRIPTION OF THE DRAWINGS

The system and methods for automatically updating schema maps in accordance with the present invention are further described with reference to the accompanying drawings in which:

FIGS. 1A and 1B are general block diagrams illustrating the automatic updating of maps based on changes to schema in a computing system in accordance with the invention;

FIG. 2A is a block diagram of a first non-limiting implementation of the invention in the context of EDI schema and EDI schema maps;

FIG. 2B is a block diagram of a second non-limiting implementation of the invention in the context of RosettaNet schema and RosettaNet schema maps;

FIG. 2C is a block diagram of a first non-limiting implementation of the invention in the context of SQL table structure schema and SQL table structure schema maps;

FIG. 3 is an exemplary non-limiting flow diagram illustrating a process for automatically updating maps based on schema changes in accordance with the invention;

FIG. 4 illustrates an exemplary common scenario where an external influence causes a schema for a business process to change, implicating the automatic updating of corresponding maps in accordance with the invention;

FIG. 5 illustrates an exemplary tool for viewing exemplary output of the automatic map updating processes in accordance with the invention;

FIGS. 6, 7, 8, 9, 10, 11 and 12 illustrate exemplary operation of a tool of the present invention via a series of screenshot user interfaces (UIs) illustrating a change to a schema affecting a map and the automatic updating of the map based on the change to the underlying schema in accordance with the invention;

FIG. 13 is an exemplary block diagram of a representative EDI communications system between a home organization having a server and trading partners of the home organization for supplemental context;

FIG. 14 is an exemplary block diagram of a representative EDI system including a hub and spoke architecture for supplemental context;

FIG. 15 is an exemplary block diagram representative of an interchange data structure including a plurality of EDI transactions for supplemental context;

FIG. 16 is an exemplary block diagram representative of background regarding schema maps, which are automatically updated according to exemplary non-limiting processes provided in accordance with the invention;

FIG. 17 is a block diagram representing an exemplary non-limiting networked environment in which the present invention may be implemented; and

FIG. 18 is a block diagram representing an exemplary non-limiting computing system or operating environment in which the present invention may be implemented.

### DETAILED DESCRIPTION

### Overview

In consideration of the lack of ability to update maps automatically when underlying schema change in today's EDI communications systems, in various non-limiting embodiments, the invention provides a tool that allows maps to be auto updated based on changes in the underlying schema, which significantly cuts down map migration cost. The tool works for EDI based maps, but can be applied to any other kind of maps predicated on schema as well. Additionally, the mechanism used to update maps can be extended to a generic scenario wherein when an entity changes, the dependent entities can be automatically modified.

In non-limiting embodiments, the invention provides a process for receiving information representative of change(s) to schema(s) in a computing system. In response to those change(s), the invention operates automatically to update schema map(s), which depend from the change(s) to the schema(s) and interrelate schemas in the computing system. Optionally, versioning information can be stored for the updated maps. An exemplary non-limiting tool allows display and/or editing of the schemas and/or schema maps, displaying changes made to maps as underlying schema evolve. The invention can be applied to any messaging system including schemas and maps between the schemas, including but not limited to EDI systems, database table structures and RosettaNet communications systems.

### Automatic Map Updating Based on Schema Changes

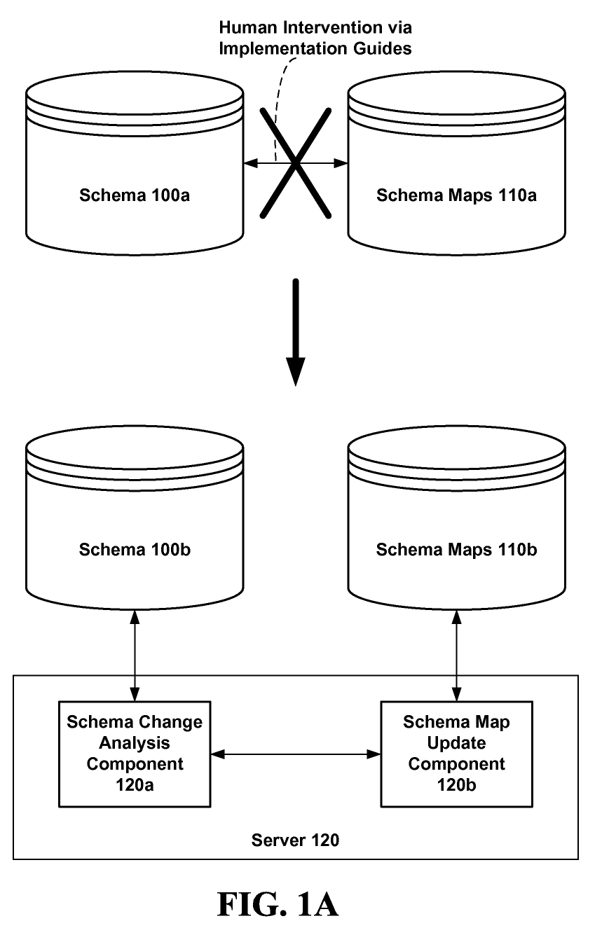

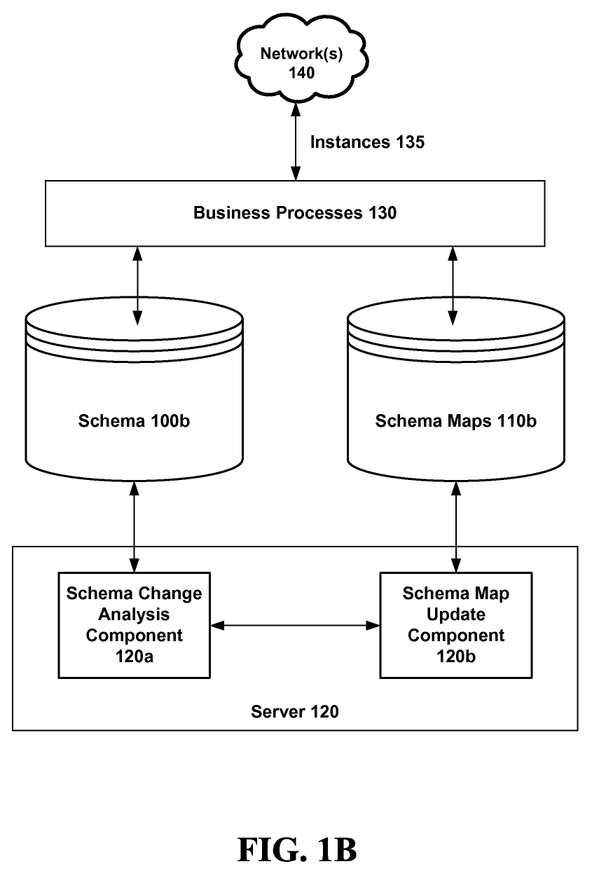

As mentioned, today, there is no automatic way to update schema maps in a computing system when the underlying schema upon which the schema maps are based evolve or otherwise change. FIG. 1A is a block diagram illustrating automatic updating of schema maps when underlying schemas change in accordance with the invention. As shown at the top of FIG. 1A, and described in the background, today a human must intervene via implementation or companion guides when changes to a schema 100a occur in order to update schema maps 110a that are affected by the changes to schema 100a.

In contrast, the system of the invention as shown at the bottom of FIG. 1A represents a beneficial advance by providing a mechanism of server 120 that enables schemas and maps to be separately maintained as schema 100b and 110b, while at the same time, when a schema of schema 100b is changed, any affected mappings of maps 110b are automatically updated to reflect the changes to the schema. In one embodiment, a first component 120a of server 120 analyzes any schema changes and presents the schema changes to a schema map update component 120b. If schema map update component 120b determines, based on the schema changes, that one or more schema maps require updating, then schema map update component 120b operates to automatically update the affected maps 110b. In this regard, a single change to a schema of schema 100b could affect many maps 110b, thus relieving any human from tedious manual intervention via implementation guides.

Schema map update component 120b also optionally versions changes to schema maps 110b over time, so that a system administrator can roll back to previous map versions and observe the corresponding schema versions, and make changes to one or the other. Exemplary non-limiting user interfaces for a tool that interfaces to the mechanism for automatically updating schema maps in accordance with the invention are described in more detail below.

As further illustrated in FIG. 1B, the separation of schema 100b and maps 110b in terms of changes and versioning in accordance with the invention enables processes 130 to continuously utilize both schema 100b (e.g., to validate documents) and schema maps 110b (e.g., to spawn related documents) while dynamically handling changes to schema 110b. Schema 110b can change at anytime during operation of processes 130, and such changes are dynamically propagated to the affected schema maps 110b so that processes 130 can continue to send, validate, process, store, receive, etc. various instances 135 of schema 110b, while versioning information is preserved. While instances 135 are shown as being received from and transmitted to one or more networks 140, instances 135 of schema 100b may be located in any storage accessible by processes 130.

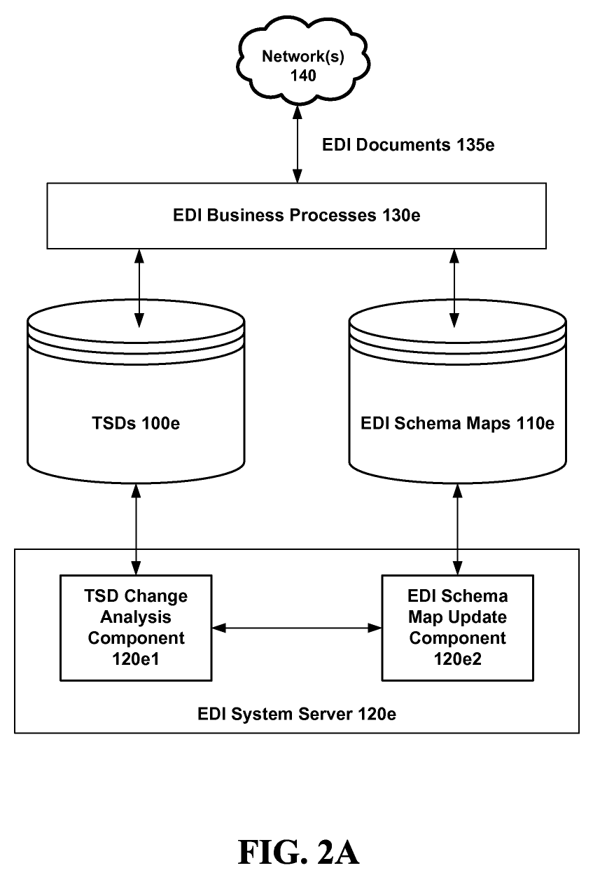

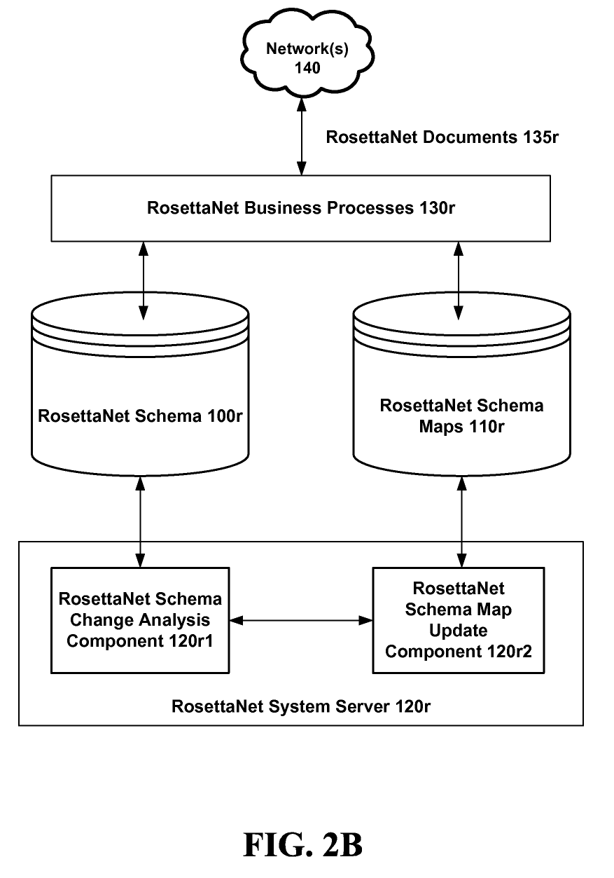

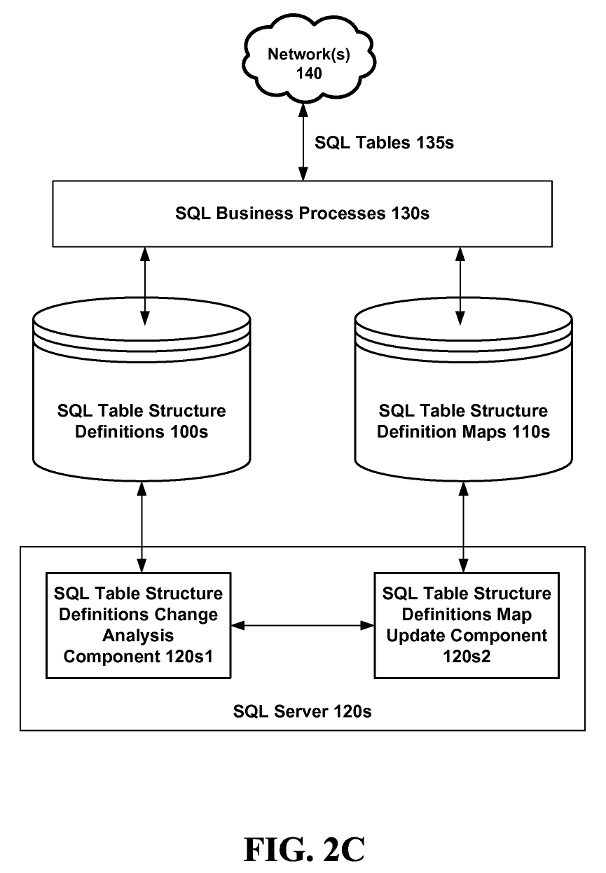

As mentioned in various non-limiting embodiments of the invention described herein, the invention applies to EDI systems. FIG. 2A illustrates various non-limiting implementations of the present invention in the context of EDI systems. As shown, EDI documents 135e are invariably sent or received via network(s) 140 to or from partners (not shown). EDI documents 135e may also be stored, retrieved, modified, processed, etc. to form other documents via various EDI business processes 130e. EDI business processes 130e can take advantage of TSDs 100e (e.g., when validating an EDI document 135e) and/or EDI schema maps 110e (e.g., to convert or translate an EDI document to another document adhering to a different schema).

Advantageously, with the invention, any changes to TSDs 100e are automatically propagated to any relevant EDI schema maps 110e that are affected by the changes. As illustrated, an EDI system server 120e includes a TSD change analysis component 120e1 that analyzes any changes to TSDs 100e. If any EDI schema maps 110e are affected by the changes to TSDs 100e, then EDI schema map update component 120e2 automatically updates the EDI schema maps 110e. In addition, as the EDI schema maps 110e evolve, EDI schema update component 120e2 of EDI system server 120e operates to version the EDI schema maps 110e so that the temporal progression of changes to schema maps 110e and underlying TSDs 100e can be observed via a tool provided in accordance with the invention.

Various non-limiting embodiments of automatic schema map updating systems in accordance with the invention are generally described herein in the context of EDI computing systems, EDI schemas such as TSDs and EDI maps for converting among such EDI schemas. However, for the avoidance of doubt, the invention is generally applicable to any computing system that includes a variety of schema and schema maps where it is desirable to automatically update the schema map(s) in response to change(s) to underlying schema.

Thus, while various embodiments are described in the context of EDI systems, the invention is not limited to EDI systems. For instance, RosettaNet is a non-profit organization dedicated to the collaborative development and rapid deployment of open, e-business process standards that align processes within global trading networks. RosettaNet standards and services provide a common language for e-business transactions and the foundation for integrating critical processes among partners within the global supply chain. Companies that use RosettaNet's standards can benefit from added cost-savings throughout supply chain processes, improved e-business communications with trading partners, enhanced product life cycle management capabilities, and added customer satisfaction.

Like EDI systems, RosettaNet systems may also store a variety of schemas and maps between the schemas for transforming among schemas. RosettaNet systems can thus also benefit from the automatic updating of maps and tools provided in accordance with the invention. For instance, FIG. 2B illustrates various non-limiting implementations of the present invention in the context of RosettaNet systems.

As shown in FIG. 2B, RosettaNet documents 135r are invariably sent or received via network(s) 140 to or from partners (not shown). RosettaNet documents 135r may also be stored, retrieved, modified, processed, etc. to form other documents via various RosettaNet business processes 130r. RosettaNet business processes 130r can take advantage of RosettaNet schema 100r (e.g., when validating a RosettaNet document 135r) and/or RosettaNet schema maps 110r (e.g., to convert or translate a RosettaNet document to another document adhering to a different schema).

Advantageously, with the invention, any changes to RosettaNet schema 100r are automatically propagated to any relevant RosettaNet schema maps 110r that are affected by the changes. As illustrated, a RosettaNet system server 120r includes a TSD change analysis component 120r1 that analyzes any changes to RosettaNet schema 100r. If any RosettaNet schema maps 110r are affected by the changes to RosettaNet schema 100r, then RosettaNet schema map update component 120r2 automatically updates the RosettaNet schema maps 110r. In addition, as the RosettaNet schema maps 110r evolve, RosettaNet schema update component 120r2 operates to version the RosettaNet schema maps 11 or so that the temporal progression of changes to schema maps 110r and underlying RosettaNet schema 100r can be observed via a tool provided in accordance with the invention.

For another example, the invention also applies to database storage, such as a structured query language (SQL) database system. In this regard, SQL server systems include the ability to create and utilize a variety of schema types that dictate the definition of SQL database table structures. For instance, FIG. 2C illustrates various non-limiting implementations of the present invention in the context of SQL server and storage systems.

As shown in FIG. 2C, SQL tables 135s are sent or received via network(s) 140. SQL tables 135s may also be stored, retrieved, modified, processed, etc. to form other documents via various SQL business processes 130s. SQL business processes 130s can take advantage of SQL table structure definitions 100s (e.g., when validating a SQL document 135s) and/or SQL table structure definition maps 110s (e.g., to convert or translate a SQL document to another document adhering to a different schema).

Advantageously, with the invention, any changes to SQL table structure definitions 100s are automatically propagated to any relevant SQL table structure definition maps 110s that are affected by the changes. As illustrated, a SQL system server 120s includes a SQL table structure definitions change analysis component 120s1 that analyzes any changes to SQL table structure definitions 100s. If any SQL table structure definition maps 110s are affected by the changes to SQL table structure definitions 100s, then SQL table structure definition map update component 120s2 automatically updates the SQL table structure definition maps 110s. In addition, as the SQL table structure definition maps 110s evolve, SQL table structure definition map update component 120s2 operates to version the SQL table structure definition maps 110s so that the temporal progression of changes to schema maps 110s and underlying SQL table structure definitions 100s can be observed via a tool provided in accordance with the invention.

SQL server is just one example of a database system that includes schema types that define the structure of database tables, and the invention is thus not to be considered limited to SQL databases, nor to databases, as the previous examples illustrate; rather, the invention applies anytime a system includes schema and maps that interrelate the schema, wherein it is desirable to automatically update the maps when the underlying schema change, and to correspondingly have the ability to version the changes to the maps.

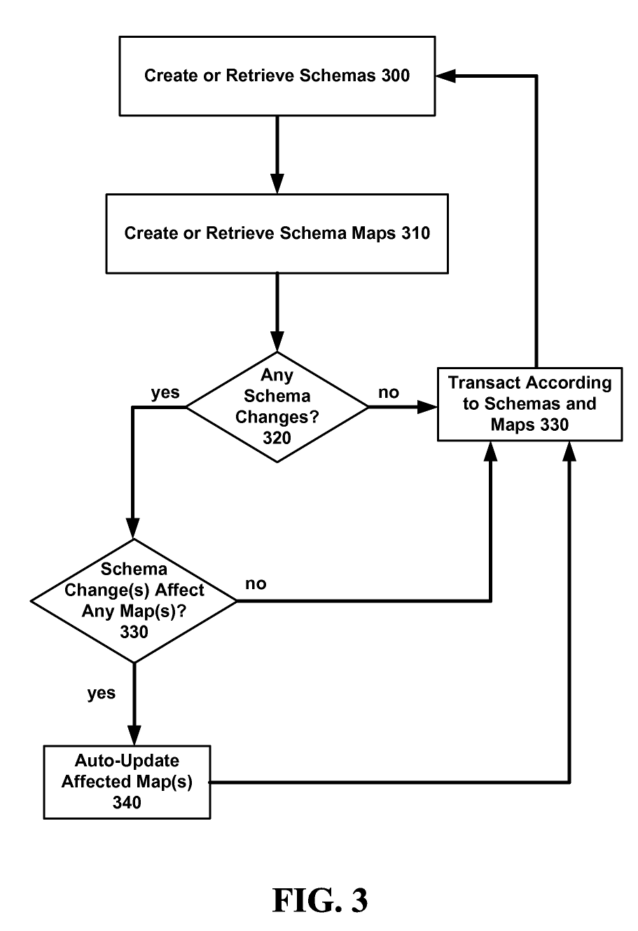

FIG. 3 is a flow diagram illustrating an exemplary non-limiting process for automatically updating maps based on schema changes in accordance with the invention. Initially, at 300, zero or more schemas are generally collected in a computing system by retrieving existing schemas and/or creating schemas at 300. At 310, zero or more schema maps are generated or created for use in connection with transacting according to schema instances and transformations between corresponding schema. Then, in accordance with the invention, at 320, it is determined whether any schema in the computing system have changes (alternatively, such changes can be pushed anytime they become available). If there have been no changes, then at 330, then the system transacts as usual based on the then-available schema and maps in the system.

If changes to one or more schemas in the system have occurred, however, then, at 330, it is determined whether such schema changes should be propagated through to maps that depend from schema including the schema changes. If not, then, at 330, the system transacts based on the updated schema and the then-available maps. If so, however, then at 340, the invention operates to automatically update each of the dependent maps based on the schema changes. The flow then proceeds to 330 for transactions according to the updated schema and updated maps. Advantageously, the automatic updating of maps at 340 allows transactions based on the schema and/or schema maps in the computing system to continue without interruption at 330.

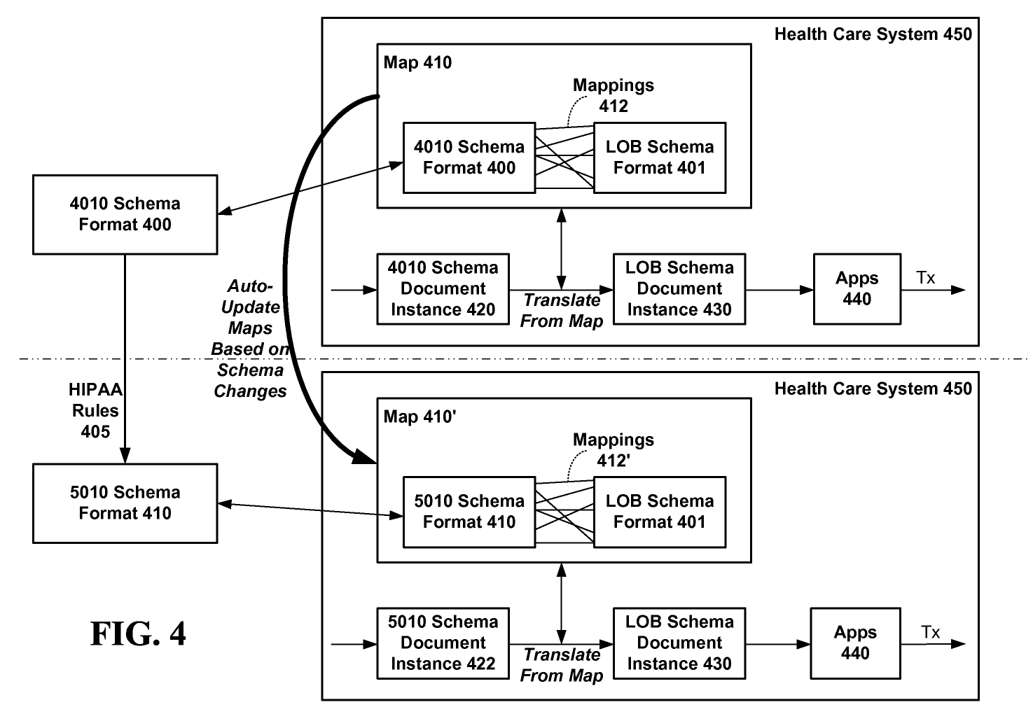

FIG. 4 illustrates an exemplary common scenario where an external influence, such as a regulation, causes a schema for a business process to change, implicating the automatic updating of corresponding maps in accordance with the invention.

Various health care data exchanges are required to conduct data exchanges consistent with the transaction standard regulations of the Health Insurance Portability and Accountability Act of 1996 (HIPAA). By way of background, HIPAA was enacted primarily to improve the portability and continuity of individual and group health insurance coverage in the United States. The HIPAA legislation mandates that health care organizations comply with HIPAA guidelines when they transmit information electronically. The goal of HIPAA is to reduce health care costs without impacting providers. To give a general idea of the scope of HIPAA requirements, today, there are over 400 different transmission formats with different content for just one of the HIPAA transactions—the health care claim. HIPAA instituted one content set and one format that all payers must accept.

FIG. 4 illustrates that the invention can be used to modify schemas in a health care system in order to conform the schemas to HIPAA regulations, such that any schema maps existing in the health care system are automatically updated based on the changes to the modified schemas, significantly reducing map migration costs associated with conforming the health care system to HIPAA standards. As an example, HIPAA rules 405 may mandate that the 5010 schema format 410 must be used in all situations where previously a 4010 schema format 400 was used. Above, the dotted line depicts the Health care system 450 prior to the HIPAA rules 405.

Prior to HIPAA rules 405, i.e., above the dotted line, health care system 450 operated to receive or retrieve 4010 schema document instances 420, and then utilizing a map file 410 having relevant mappings between elements of a 4010 schema format 400 and a LOB schema format 401, health care system 450 translates the 4010 schema document instance 420 to a line of business (LOB) schema document instance 430 for further transacting TX by applications 440.

After HIPAA rules 405 are enacted, i.e., below the dotted line, it is desirable to have health care system 450 operate to receive or retrieve 5010 schema document instances 422, and then map accordingly to LOB schema document instance 430 as usual. However, without the invention, map 410 will not reflect how to perform such translation and a system administrator will be required to create a new map that maps from the 5010 schema format 410 to LOB schema format 401. However, with the invention, map 410 is automatically updated to map 410′ with updated mappings 412′ based on the schema changes from 4010 schema format 400 to the 5010 schema format 410. As a result, human intervention is unnecessary and 5010 document instances 422 are properly translated based on map 410′ to LOB schema document instances 430 so that Apps 440 and transactions TX behave as usual, making migration to new schema seamless to health care system 450.

As mentioned, in all the foregoing and other scenarios in which the invention may be implemented, the invention includes a mechanism for versioning the maps as they are automatically updated in order to preserve the change history for schema maps. The invention also includes various non-limiting tools for viewing the versioned maps, to change the underlying schema, and to automatically update any maps that depend upon such schema. The invention thus provides a tool that allows maps to be automatically updated based on changes in the underlying schema, which significantly cuts down map migration costs.

### Non-Limiting Embodiments of Automap Update for EDI Systems

Additional context regarding EDI systems is described below, but in brief, EDI is the computer-to-computer exchange of business information using ‘approved’ formatting standards. Millions of companies around the world use EDI to conduct commerce. EDI data is transmitted as delimited files without self-describing tags and therefore the encoding rules enforce very strict formatting rules to ensure the destination application is able to successfully parse and consume the information for down stream processing.

TSDs are the EDI schema files of EDI systems, and are typically delivered as XSD Schemas. In this regard, TSDs evolve as business requirements change or changes are mandated by Standards Development Organizations (SDOs) or other regulatory or compliance bodies. However created, changes to EDI schemas have ripple effects on dependent maps thereby significantly, and in some cases, prohibitively increasing the development effort to manually update the maps when compared to the scenario where only schemas are modified.

A tool is thus provided in accordance with the invention that auto-updates any dependent maps to reflect schema changes, thus reducing total development time. In one non-limiting implementation, the invention includes a migration utility that performs map migration in addition to schema migration in order to migrate older schemas and maps found on an older EDI system to a newer EDI system. In such implementation, during schema migration, changes to the schema are recorded (root node name change, target namespace change, attribute to element conversion) and then, utilizing the present invention, the changes to the schema are percolated to maps, e.g., maps selected by the user. As an optional extension, the invention can be applied to other kinds of schema changes in the form of ‘schema diff-grams’ which could be moving of nodes within the schema, node name change at any level, structural changes to schema, etc. Another application of the invention includes automatically updating maps when an underlying schema changes.

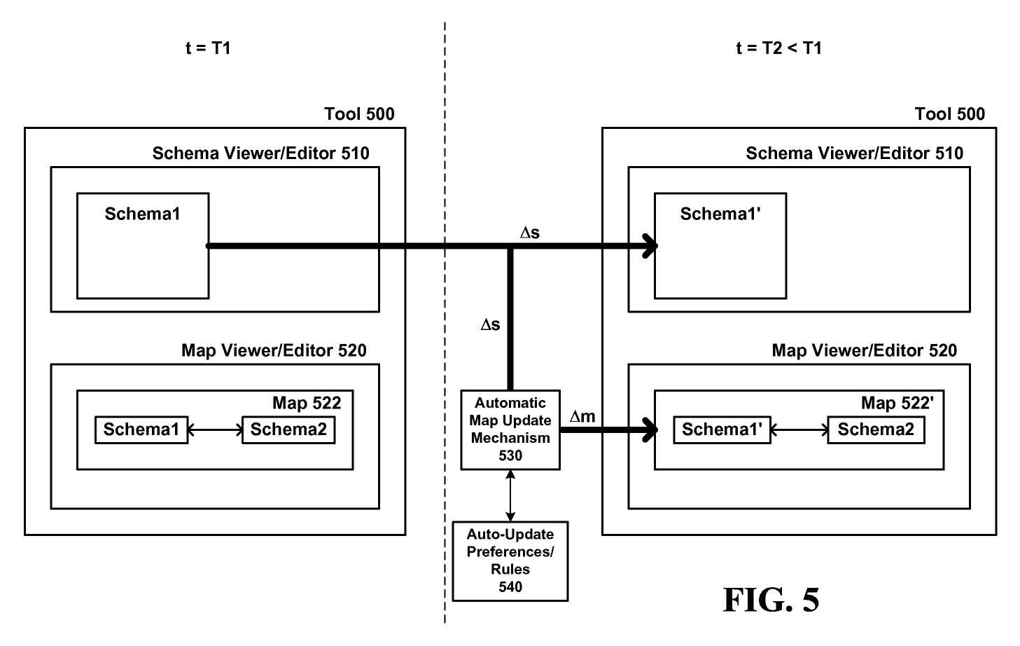

FIG. 5 illustrates an exemplary non-limiting tool 500 for viewing exemplary output of the automatic map updating processes in accordance with the invention. Tool 500 includes a schema viewer and/or editor 510 and a map viewer and/or editor 520. Schema, such as Schema1, can be viewed and/or edited via component 510, and maps, such as map 522, can be viewed and/or edited via component 520. As mentioned, a mechanism 530 is provided in accordance with the invention that operates to automatically update any dependent maps when a schema changes. Thus, in the presently described non-limiting embodiment of the invention as tool 500, when a schema is edited in the system at time t=T1, the changes Δs are recorded and a subsequent version of schema1 is created as schema1′. Optionally, component 510 allows a viewer to see the changes Δs between the different versions schema1′ and schema1.

At the same time, in accordance with the invention, the schema changes Δs are sent to mechanism 530 to determine whether any dependent maps should be automatically updated. This can be performed automatically or optionally based on a party's preferences or rules 540 for determining when automatic update should be performed. If it is determined that automatic update should be performed for any dependent maps, then at time t=T2 (after T1), the invention operates to automatically update those dependent maps. For instance, in FIG. 5, the changes As to schema1 to form schema1′ affect map 522 which reflects mappings from schema1 to schema2, and vice versa. Thus, the invention operates to automatically update map 522 to map 522′ taking into account the changes Δs from schema1 to the subsequent version schema1′.

The invention also may store versioning information with map 522′ so that a user may easily view all of the changes Δm from map 522 to map 522′ made as a result of the schema changes Δs from schema1 to schema1′. The invention thus not only automates the process of updating dependent maps when underlying schema(s) change, but also makes change and version history available for all of the system's schema maps, so that a user can see exactly how the system maps are evolving over time.

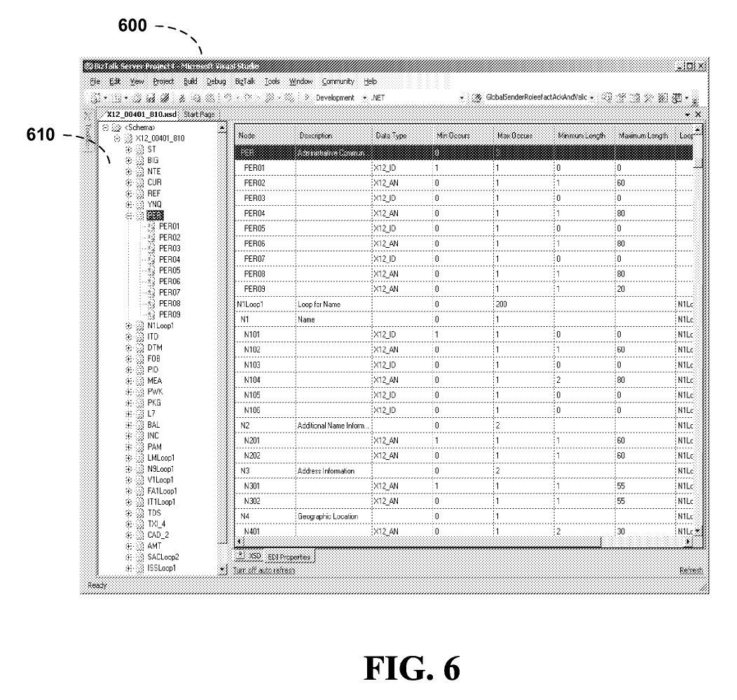

FIGS. 6-12 are exemplary non-limiting screenshot UIs for a sample tool for allowing changes to a schema that illustrate the automatic updating of affected maps based on the changes to an underlying schema in accordance with the invention. Exemplary non-limiting screenshot UI 600 of FIG. 6 shows an X12 Invoice schema 610, formally for version 00401 and transaction ID 810. According to its structure, schema 610 contains several loops and segments, which in turn contain simple fields, component fields and composite data types. An advantage of this sample tool is that each EDI trading partner or organization can customize this schema 610 to meet their own business or other requirements.

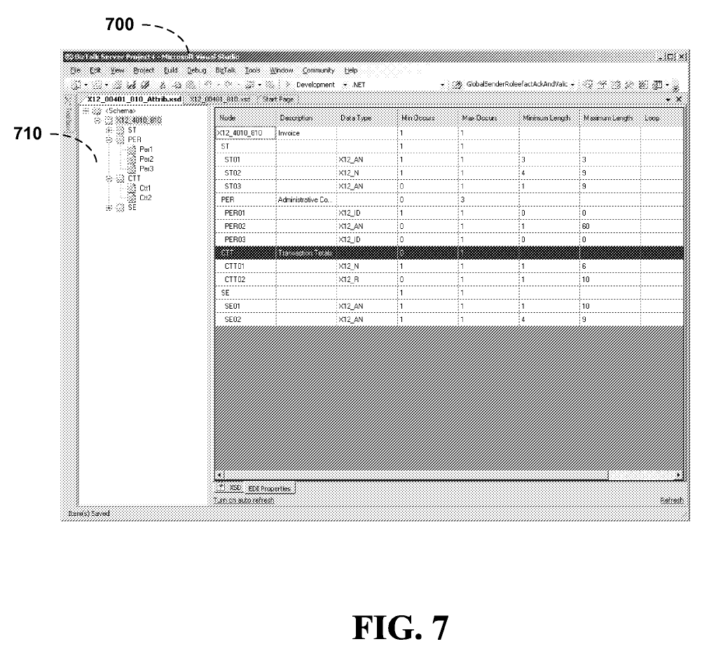

For illustrative purposes, exemplary non-limiting screenshot UI 700 of FIG. 7 shows a highly simplified Invoice schema 710 which contains attributes to carry individual units of data. Invoice schema 710 contains 4 segments, ST, PER, CTT and SE. An organization might prefer business processes or display of data based on invoice schema 710 wherever simplicity of information is preferable to the complex representation of schema 610 of FIG. 6.

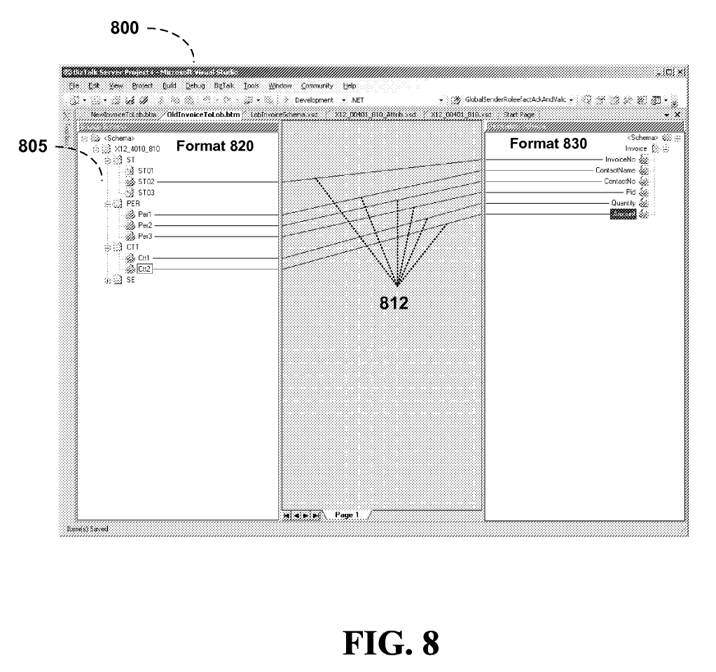

As shown in FIG. 8, schema 710 of FIG. 7 can then be used to create a schema map 805, which converts an EDI document received from a trading partner according to a first format 820 to a second format 830, e.g., a format that a line of internal business applications can understand. Screenshot UI 800 of FIG. 8 thus illustrates a map 805 between an EDI Invoice schema 820 and line of business (LOB) Invoice schema 830 via schema element mappings 812.

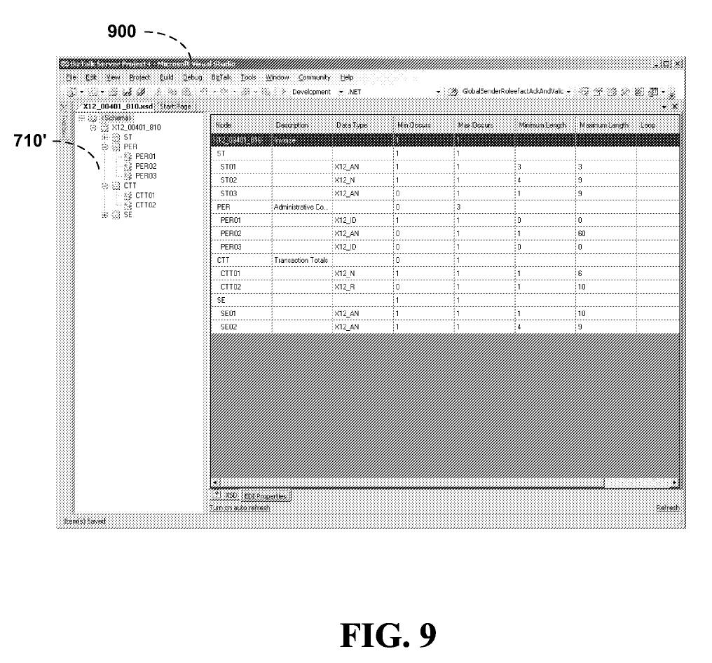

Once generated, schema 610 and 710 of FIGS. 6 and 7 and map 805 of FIG. 8 might thus be in general use in a production system for business transactions for a particular organization. Over a period of time, however, the business requirements for the organization could change, thus requiring a change in EDI Invoice schema 710. For instance, perhaps under new requirements, it would be desirable for the organization to modify schema 710 to create a new schema 710′ as shown in screenshot UI 900 of FIG. 9. The new EDI schema 710′ is quite different from the original schema 710. The changes between EDI schema 710′ of FIG. 9 and EDI schema 710 include:

Δ1: Root node name change from X12_{—}4010_{—}810 to X12_{—}00401_{—}810

Δ2: Per1 name change to PER01

Δ3: Per1 has been converted from an attribute to an element

Δ4: Per2 name change to PER02

Δ5: Per2 has been converted from an attribute to an element

Δ6: Per3 name change to PER03

Δ7: Per1 has been converted from an attribute to an element

Δ8: Ctt1 name change to CTT01

Δ9: Ctt1 has been converted from an attribute to an element

Δ10: Ctt2 name change to CTT02

Δ11: Ctt2 has been converted from an attribute to an element

In accordance with the invention, the above list of eleven changes A1 to Δ11 are then automatically applied to all maps in the EDI system, such as map 805 of FIG. 8, that were using, or based on, the older Invoice schema 710 in order for them to continue to be valid. While only map 805 is used here as an example, former schema 710 could have been used in numerous maps, thus making the problem even more severe.

In addition, real world experience has indicated that map migration is an extremely time consuming, error-prone and expensive process. Accordingly, to solve these and other problems, the invention thus provides a tool that receives a map file and a list of schema changes and applies any applicable schema changes to the map file to update the map file. The tool can be beneficial for automating map migration processes.

As mentioned, in non-limiting embodiments of the invention, during schema migration, the tool of the invention can keep track of all the changes that have been made to any maps as a result. Exemplary types of changes include name change, attribute to element conversion, target namespace change, etc. Optionally, these changes are maintained in such a way so that both the old version and the new version are maintained.

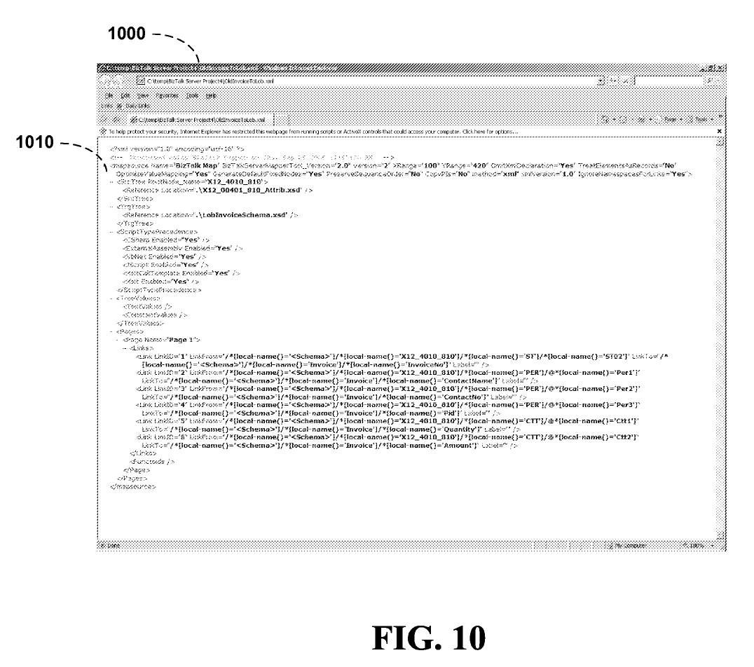

A typical map file consists of links that contain references to nodes from one schema to another. A sample map file 1010 represented in markup language is on display in screenshot UI 1000 of FIG. 10 showing the specification for map 805 of FIG. 8. In accordance with the invention, the tool of the invention goes over all the links of the map file 1010 and appropriately applies the changes that were made to any underlying schema. Thus, where applicable, the tool of the invention updates the maps to reflect the new names, attribute to element conversion, root node change and/or any other changes to the underlying schema.

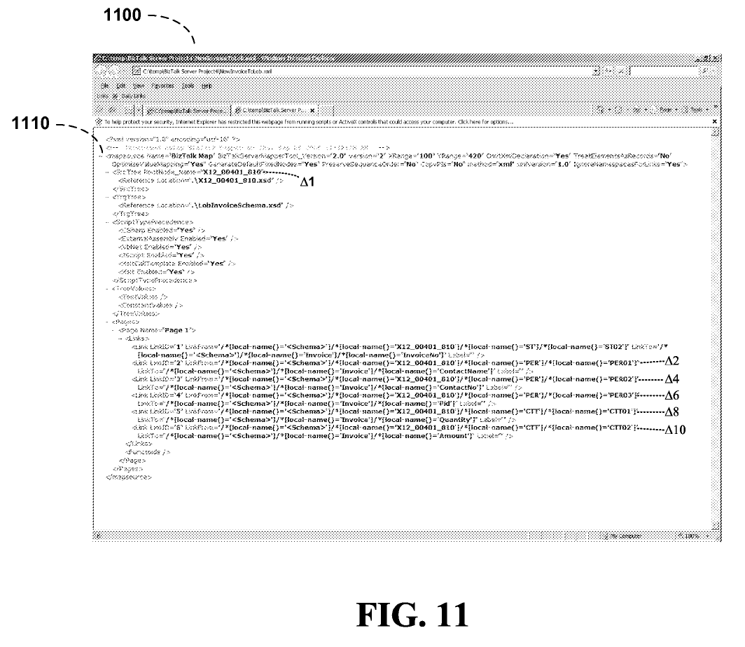

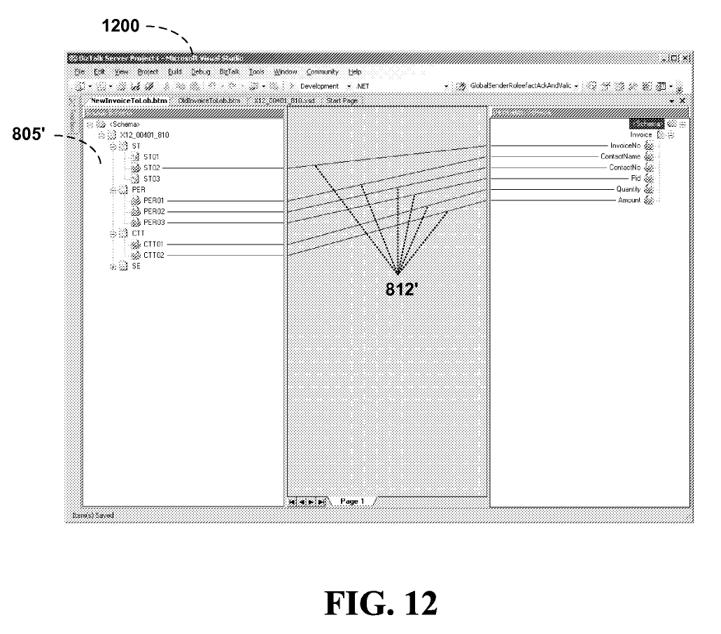

The automatically updated map specification 1110 is shown in the exemplary non-limiting screenshot 1100 of FIG. 11. Some of the changes Δ1 to Δ11 described above are pointed out in FIG. 11, namely Δ1, Δ2, Δ4, Δ6, Δ8 and Δ10 are shown in the Figure. FIG. 12 illustrates the corresponding map representation 805′ having updated mappings 812′ in exemplary screenshot UI 1200. Map representation 805′ is a visual representation of the XML representation of map specification 1110, which is generated in accordance with the invention by automatically updating map representation 805 based on changes Δ1 to Δ11 to underlying schema 710.

### Supplemental Context Regarding EDI Messaging Systems

While the invention is by no means limited to EDI schema, EDI schema maps or EDI messaging systems, for supplemental context regarding EDI, EDI is the exchange of structured information, by agreed upon messaging standards, from one computer or computer application to another by electronic means with minimal human intervention. Based on approved formatting standards and schemas, EDI is one of the ways businesses exchange computer-to-computer business information. For example, millions of companies around the world transmit and store data associated with business transactions (e.g., purchase orders, shipping/air bills, invoices, or the like) using EDI to conduct commerce.

EDI may thus be defined as computer-to-computer exchange of business information using ‘approved’ formatting standards, referring to specific interchange methods agreed upon by national or international standards bodies for the transfer of business transaction data. One typical application for EDI messaging is the automated purchase of goods and services, though EDI messages are by no means limited to any particular kind of business data. In this regard, millions of companies around the world use EDI to conduct commerce. In raw format, EDI data is transmitted as delimited files (without self describing tags) and therefore the encoding rules enforce very strict formatting rules to ensure the destination application is able to successfully parse and consume the information for down stream processing.

In EDI terminology, organizations that send or receive documents from each other are referred to as “trading partners”. The trading partners agree on the specific information to be transmitted and how it should be used. Service providers provide global platforms (also known as trading grids) to connect and integrate “business partners” around the world. They provide integration platforms that make the exchange of EDI (or XML) documents transparent and easy between diverse constituents. These providers also track and reconcile documents to reduce errors and improve supply chain performance.

EDI translation software provides the interface between the internal system and the common standards and applies to both “inbound” documents and “outbound” documents. Translation software may also utilize other methods or file formats translated to or from EDI.

It can be appreciated by those of skill in the art that the structured information of EDI files can also be represented with the extensible markup language (XML), and vice versa. Despite the use of EDI being somewhat unheralded relative to its counterpart XML, EDI files are still the data format used in a majority of electronic commerce transactions in the world.

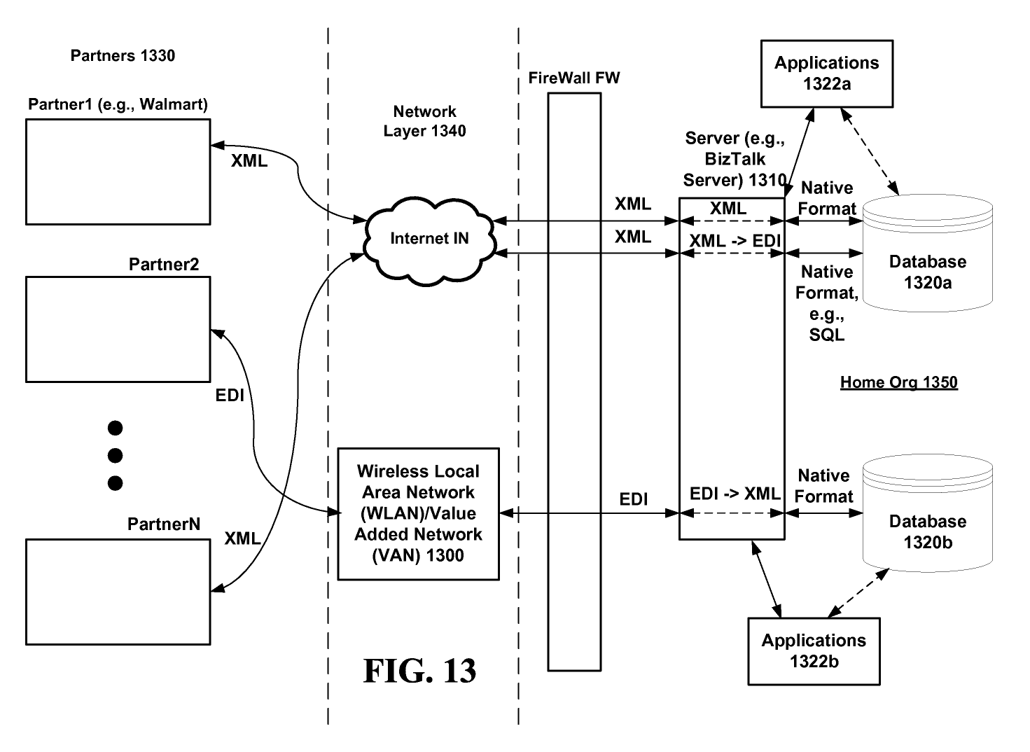

In the exemplary EDI system for a home organization 1350 shown in FIG. 13, typically server software 1310, such as Microsoft's BizTalk Server, can be deployed to interact outside of the home organization 1350 via network layer 1340 and to interface with databases 1320a, 1320b, etc. so that various applications 1322a, 1322b, etc., can interact with the automated storage of business records received by databases 1320a, 1320b, etc. EDI files or XML representations of EDI files can be received via Internet IN, or a wireless local area network (WLAN) or value added network (VAN) 1300 of network layer 1340, e.g., through firewall FW, and such EDI/XML messages can be received from any of a variety of trading partners 1330, i.e., partner1, partner2, . . . , partnerN. Server 1310 can handle any of the necessary conversions and parsing of EDI files or XML representations thereof, and any conversions to or from a native database format, such as SQL.

Typically, when EDI messages are received, a server receiving the EDI messages can answer in terms of an acknowledgment of receipt of the EDI messages to its trading partner. The server will specify whether the EDI message is invalid according to the schema, and if invalid, will specify why, or the server will specify that the EDI message was accepted, accepted with errors or rejected.

Internet IN has enabled EDI transactions to be transmitted between trading partners in an even more efficient manner. Internet IN provides business and government agencies with an environment that is open, fast, cost effective, and widely accepted and used.

VAN 1300 is a mechanism that facilitates the transfer of electronic data between trading partners. A VAN 1300 can be thought of as a post office, or a dedicated pipe, which allows an entity to send EDI formatted data to one of their trading partners at any time. The VAN 1300 will hold the file of transmitted transactions until the trading partner to whom it is addressed retrieves it at a later time.

EDI standards were designed to be independent of lower level technologies and can be transmitted using Internet protocols, such as the file transfer protocol (FTP), telnet and email, as well as private networks, such as value-added networks (VANs). EDI documents contain the same data that would normally be found in a paper document used for the same organizational function. For example, an EDI ship-from-warehouse order might be used by a manufacturer to tell a warehouse to ship product(s) to a retailer. It typically has a ship to address, bill to address, a list of product numbers (e.g., a UPC code) and quantities. It may also have other information if the parties agree to include it. However, EDI is not confined to just business data directly related to trade, rather but encompasses all fields such as medicine (patient records, laboratory results, etc.), transport (container and modal information, etc.), engineering and construction, etc., i.e., anywhere a first entity may wish to automate the exchange of data with another entity.

In a typical EDI transaction model, a large business entity or an EDI integration broker trades with numerous partners and has the technical capability to handle numerous EDI transaction data in various EDI formats and schemas. These entities, also known as “hubs,” transact with one or more suppliers, also known as “spokes.” Each of the spokes typically is a relatively small business entity that is only capable of dealing with one hub. Before the spokes attempt to initiate transactions via EDI with the hub, the hub typically transmits various EDI schemas to the spokes so that the spokes can properly format the EDI transactions according to the EDI schemas.

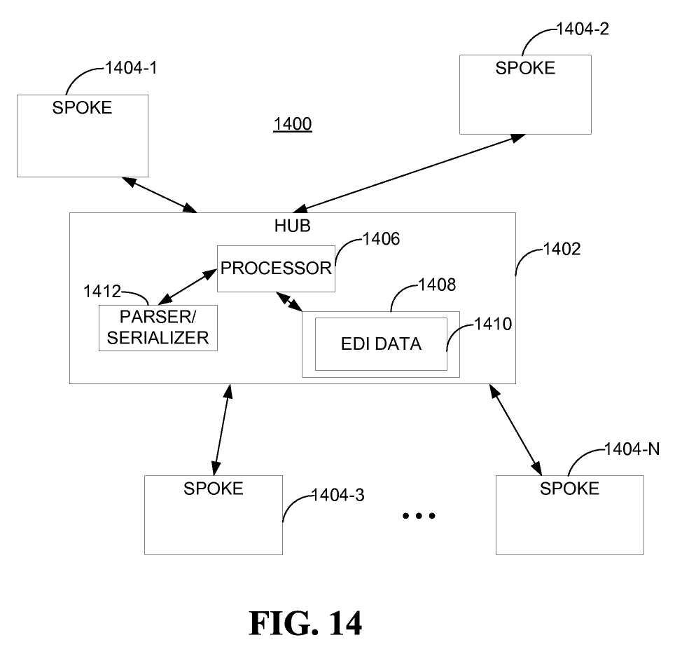

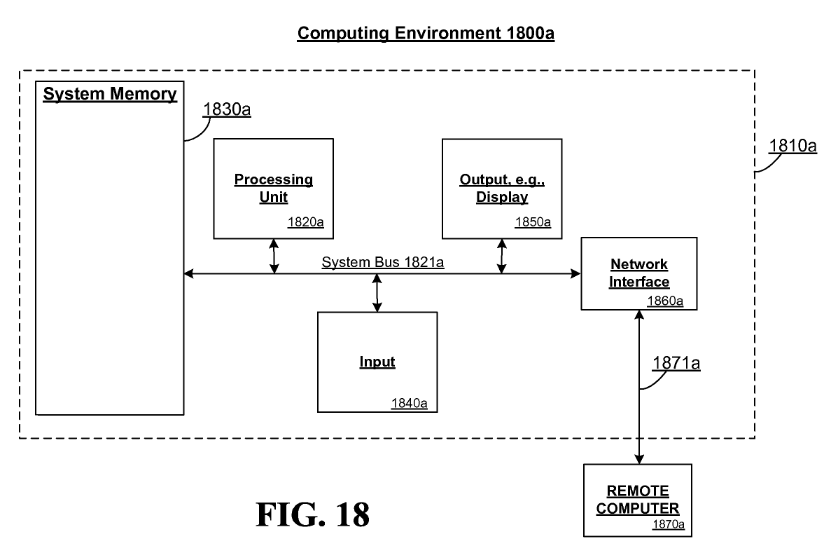

FIG. 14 is a block diagram illustrating a system for conducting EDI transactions according to exemplary non-limiting embodiments of the invention. A system 1400 is illustrated for conducting EDI transactions. System 1400 includes a hub 1402 linked to and communicating with one or more spokes (e.g., spokes 1404-1, 1404-2, 1404-3, . . . , 1404-N). In one embodiment, the hub 1402 includes a server computer or a computing device serving one or more processors (e.g., processor 1406) or processing units for executing computer-executable instructions for serving the spokes 1404. In one example, the spokes 1404 include a computing device having one or more components included in or coupled with a computer 1430, as shown in FIG. 18.

In one example, the hub 1402 also includes a memory area 1408 for storing one or more EDI schemas, such as an EDI schema 1410. Initially, the hub 1402 and the spokes 1404-1, 1404-2, 1404-3, . . . , 1404-N establish agreements as to the EDI formats or standards to be used for transmitting transaction data therebetween. Once the parties determine the particular EDI formats or standards to use, the hub 1402 selects the appropriate EDI schemas to be transmitted to the spokes 1404-1, 1404-2, 1404-3, . . . , 1404-N. In another example, the hub 1402 may choose to select all EDI schemas for all types of transactions, such as purchase orders, bills of lading, invoices, payrolls, or the like, to the spokes 1404-1, 1404-2, 1404-3, . . . , 1404-N.

Although the communications between the hub 1402 and the spokes 1404-1, 1404-2, 1404-3, . . . , 1404-N can be a private or public communications network, a wired or wireless network, the spokes 1404-1, 1404-2, 1404-3, . . . , 1404-N typically lack the hardware resources to handle large amount of EDI schemas sent from the hub 1402. In addition, the type and bandwidth of computing network communications for the spokes 1404-1, 1404-2, 1404-3, . . . , 1404-N are not equipped to handle such demand imposed by the thousands of EDI schemas, which can reach several Gigabytes in data size.

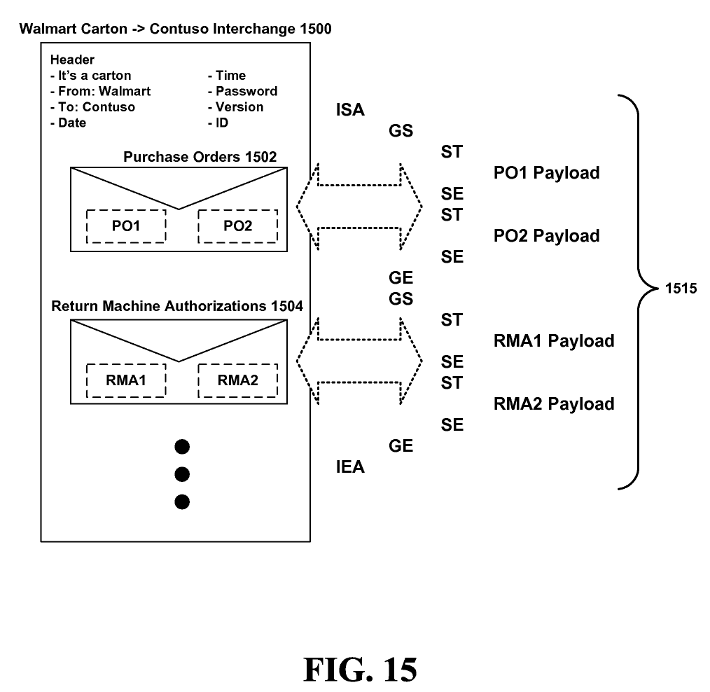

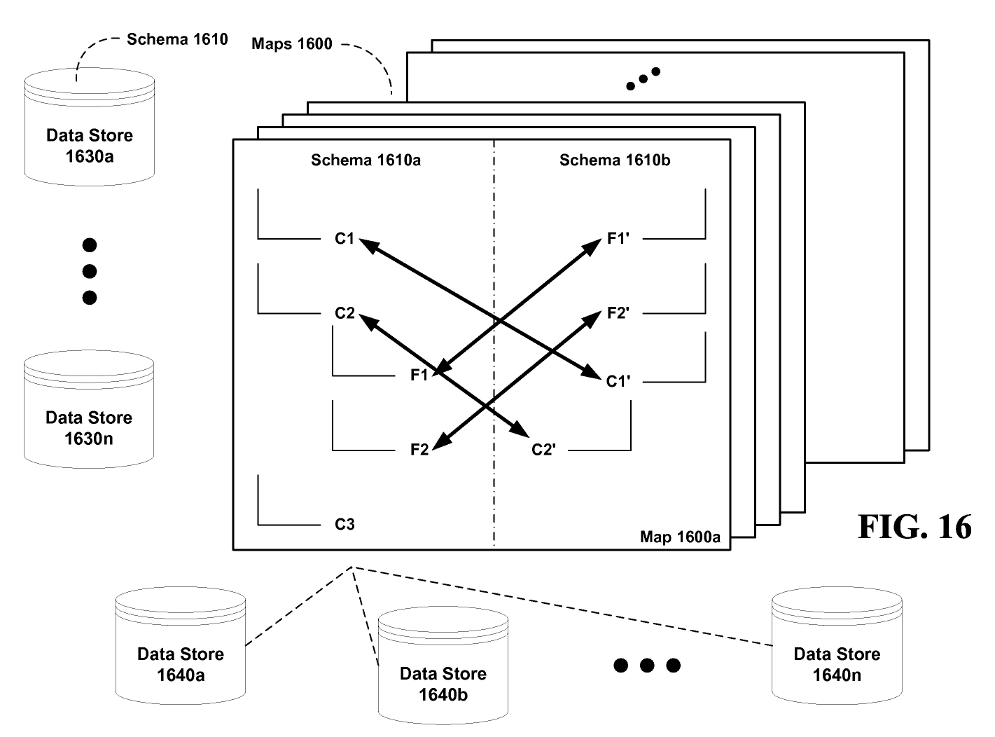

FIG. 15 in turn illustrates that an organization can generate an interchange 1500—a sort of carton for EDI messages—which includes a plurality of EDI messages. Interchange 1500 typically includes a header which includes a type of document, from whom the document originated, to whom the document is addressed, the date, the time, any password information, version information, identification information, and the like. Then the interchange 1500 lists a series of purchase orders 1502 and return machine authorizations (RMAs) 1504, conceptually shown as envelopes in the carton. In turn, each envelope conceptually represents one or more individual EDI files, or messages. For instance, purchase orders 1502 include individual purchase orders PO1 and PO2, and RMAs 1504 include RMAs RMA1 and RMA2, and so on.

In turn, there is a flat file native EDI format that corresponds to this conceptual relationship between carton->envelopes->messages. As illustrated by shell 1515 corresponding to the conceptual representation, the ISA<->IEA indent level represents the beginning and end of the interchange (carton). The GS and GE indent levels represent the beginning and end of any envelopes within the carton, and the ST and SE indent levels represent the beginning and end of any messages within an envelope, i.e., between any ST and SE will be an individual message payload, such as PO1 Payload, PO2 Payload, RMA1 Payload and RMA2 Payload.

There are several advantages of using EDI all of which provide distinct benefits to the user. One of the most notable benefits to using EDI is the timesaving capability it provides. By eliminating the process of distributing hard copies of information throughout the company, easy access to electronic data simplifies inter-department communication. In addition, another timesavings advantage is the ability to track the origin of all information therefore significantly reducing time spent on corresponding with the source of the information.

Another benefit for the user of this information system is the ultimate savings in costs for an organization. Although the initial set-up costs may seem high, the overall savings received in the long run ensures its value. For any business, regardless of its size, hard-copy print outs and document shipping costs add up. EDI allows for a paper-less exchange of information reducing handling costs and worker productivity that is involved with the organization of paper documents.

EDI has another strong advantage over paper-based information exchange, which has to do with accuracy of information. When the information is already stored electronically, it speeds up an organizations ability to check for accuracy and make any necessary corrections as the data is already input to the system. Also, unlike paper-based methods, EDI allows for the ability to send and receive information at any time thereby tremendously improving an organizations ability to communicate quickly and efficiently.

A disadvantage of using EDI involves the initial set-up. The preliminary expenses and time that arise from the implementation, customization and training can be costly. However, as EDI systems continue to improve, such as by using the batching membership evaluation techniques of the invention, such disadvantage is disappearing as ease of use increase.

### EDIFACT and X12 Standards for EDI Documents

There are two major sets of EDI standards which can be used to generate and receive/process EDI messages: the United Nations Electronic Data Interchange for Administration, Commerce and Transport, which is a translation of UN/EDIFACT (“EDIFACT”) and the American National Standards Institute's (ANSI) Accredited Standards Committee (ASC) X12 (“X12”). Both used worldwide, X12 tends to be more popular in North America than EDIFACT. These standards prescribe the formats, character sets, and data elements used in the exchange of documents and forms, such as invoices and purchase orders, e.g., purchase orders are called “ORDERS” in EDIFACT and “850s” in X12.

Whichever selected, the standard dictates which pieces of information are mandatory for a particular document, which pieces are optional and gives the rules for the structure of the document. In this regard, with optional pieces, two EDI documents can follow the same standard and contain different sets of information. For example, a food company might indicate a particular product expiration date while a clothing manufacturer might choose to send color and size information.

### Exemplary Networked and Distributed Environments

One of ordinary skill in the art can appreciate that the invention can be implemented in connection with any computer or other client or server device, which can be deployed as part of a computer network, or in a distributed computing environment, connected to any kind of data store. In this regard, the present invention pertains to any computer system or environment having any number of memory or storage units, and any number of applications and processes occurring across any number of storage units or volumes, which may be used in connection with processes for automatically updating schema maps in accordance with the present invention.

The present invention may apply to an environment with server computers and client computers deployed in a network environment or a distributed computing environment, having remote or local storage. The present invention may also be applied to standalone computing devices, having programming language functionality, interpretation and execution capabilities for generating, receiving and transmitting information in connection with remote or local services and processes.

Distributed computing provides sharing of computer resources and services by exchange between computing devices and systems. These resources and services include the exchange of information, cache storage and disk storage for objects, such as files. Distributed computing takes advantage of network connectivity, allowing clients to leverage their collective power to benefit the entire enterprise. In this regard, a variety of devices may have applications, objects or resources that may implicate the systems and methods for automatically updating schema maps in accordance with the invention.

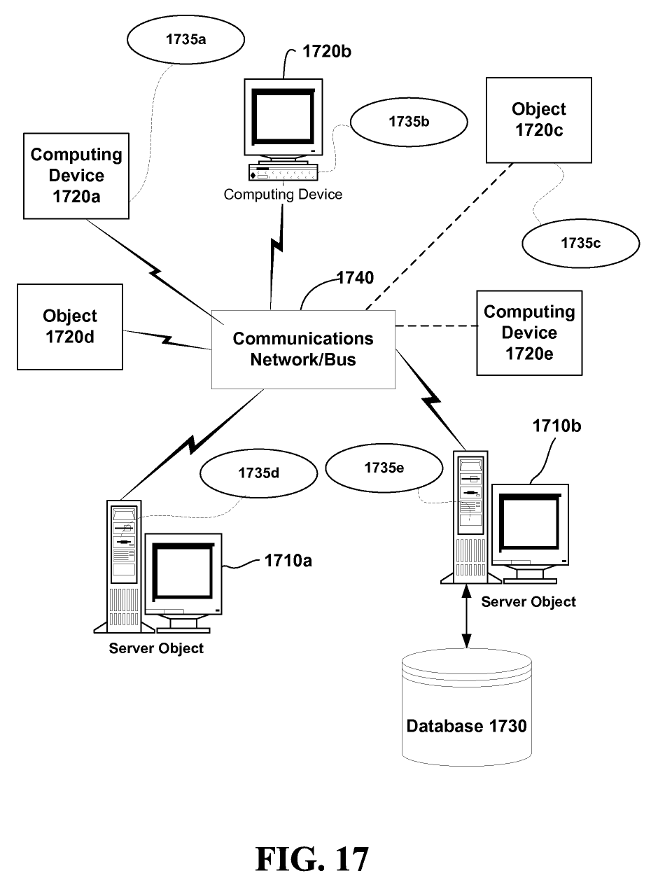

FIG. 17 provides a schematic diagram of an exemplary networked or distributed computing environment. The distributed computing environment comprises computing objects 1710a, 1710b, etc. and computing objects or devices 1720a, 1720b, 1720c, 1720d, 1720e, etc. These objects may comprise programs, methods, data stores, programmable logic, etc. The objects may comprise portions of the same or different devices such as PDAs, audio/video devices, MP3 players, personal computers, etc. Each object can communicate with another object by way of the communications network 1740. This network may itself comprise other computing objects and computing devices that provide services to the system of FIG. 17, and may itself represent multiple interconnected networks. In accordance with an aspect of the invention, each object 1710a, 1710b, etc. or 1720a, 1720b, 1720c, 1720d, 1720e, etc. may contain an application that might make use of an API, or other object, software, firmware and/or hardware, suitable for use with the systems and methods for automatically updating schema maps in accordance with the invention.

It can also be appreciated that an object, such as 1720c, may be hosted on another computing device 1710a, 1710b, etc. or 1720a, 1720b, 1720c, 1720d, 1720e, etc. Thus, although the physical environment depicted may show the connected devices as computers, such illustration is merely exemplary and the physical environment may alternatively be depicted or described comprising various digital devices such as PDAs, televisions, MP3 players, etc., any of which may employ a variety of wired and wireless services, software objects such as interfaces, COM objects, and the like.

There are a variety of systems, components, and network configurations that support distributed computing environments. For example, computing systems may be connected together by wired or wireless systems, by local networks or widely distributed networks. Currently, many of the networks are coupled to the Internet, which provides an infrastructure for widely distributed computing and encompasses many different networks. Any of the infrastructures may be used for exemplary communications made incident to automatically updating schema maps according to the present invention.

In home networking environments, there are at least four disparate network transport media that may each support a unique protocol, such as Power line, data (both wireless and wired), voice (e.g., telephone) and entertainment media. Most home control devices such as light switches and appliances may use power lines for connectivity. Data Services may enter the home as broadband (e.g., either DSL or Cable modem) and are accessible within the home using either wireless (e.g., HomeRF or 802.11B) or wired (e.g., Home PNA, Cat 5, Ethernet, even power line) connectivity. Voice traffic may enter the home either as wired (e.g., Cat 3) or wireless (e.g., cell phones) and may be distributed within the home using Cat 3 wiring. Entertainment media, or other graphical data, may enter the home either through satellite or cable and is typically distributed in the home using coaxial cable. IEEE 1394 and DVI are also digital interconnects for clusters of media devices. All of these network environments and others that may emerge, or already have emerged, as protocol standards may be interconnected to form a network, such as an intranet, that may be connected to the outside world by way of a wide area network, such as the Internet. In short, a variety of disparate sources exist for the storage and transmission of data, and consequently, any of the computing devices of the present invention may share and communicate schema and schema map data in any existing manner, and no one way described in the embodiments herein is intended to be limiting.

The Internet commonly refers to the collection of networks and gateways that utilize the Transmission Control Protocol/Internet Protocol (TCP/IP) suite of protocols, which are well-known in the art of computer networking. The Internet can be described as a system of geographically distributed remote computer networks interconnected by computers executing networking protocols that allow users to interact and share information over network(s). Because of such wide-spread information sharing, remote networks such as the Internet have thus far generally evolved into an open system with which developers can design software applications for performing specialized operations or services, essentially without restriction.

A network infrastructure enables a host of network topologies such as client/server, peer-to-peer, or hybrid architectures. The “client” is a member of a class or group that uses the services of another class or group to which it is not related. Thus, in computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the illustration of FIG. 17, as an example, computers 1720a, 1720b, 1720c, 1720d, 1720e, etc. can be thought of as clients and computers 1710a, 1710b, etc. can be thought of as servers although any computer can be considered a client, a server, or both, depending on the circumstances. Any of these computing devices may be processing data or requesting services or tasks that may implicate the systems and methods for automatically updating schema maps in accordance with the invention.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques for automatically updating schema maps in accordance with the invention may be distributed across multiple computing devices or objects.

Client(s) and server(s) communicate with one another utilizing the functionality provided by protocol layer(s). For example, HyperText Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over a communications medium, e.g., client(s) and server(s) may be coupled to one another via TCP/IP connection(s) for high-capacity communication.

Thus, FIG. 17 illustrates an exemplary networked or distributed environment, with server(s) in communication with client computer (s) via a network/bus, in which the present invention may be employed. In more detail, a number of servers 1710a, 1710b, etc. are interconnected via a communications network/bus 1740, which may be a LAN, WAN, intranet, GSM network, the Internet, etc., with a number of client or remote computing devices 1720a, 1720b, 1720c, 1720d, 1720e, etc., such as a portable computer, handheld computer, thin client, networked appliance, or other device, such as a VCR, TV, oven, light, heater and the like in accordance with the present invention. It is thus contemplated that the present invention may apply to any computing device in connection with which it is desirable to automatically update schema maps based on schema changes.

In a network environment in which the communications network/bus 1740 is the Internet, for example, the servers 1710a, 1710b, etc. can be Web servers with which the clients 1720a, 1720b, 1720c, 1720d, 1720e, etc. communicate via any of a number of known protocols such as HTTP. Servers 1710a, 1710b, etc. may also serve as clients 1720a, 1720b, 1720c, 1720d, 1720e, etc., as may be characteristic of a distributed computing environment.

As mentioned, communications may be wired or wireless, or a combination, where appropriate. Client devices 1720a, 1720b, 1720c, 1720d, 1720e, etc. may or may not communicate via communications network/bus 14, and may have independent communications associated therewith. For example, in the case of a TV or VCR, there may or may not be a networked aspect to the control thereof. Each client computer 1720a, 1720b, 1720c, 1720d, 1720e, etc. and server computer 1710a, 1710b, etc. may be equipped with various application program modules or objects 135a, 135b, 135c, etc. and with connections or access to various types of storage elements or objects, across which files or data streams may be stored or to which portion(s) of files or data streams may be downloaded, transmitted or migrated.

Any one or more of computers 1710a, 1710b, 1720a, 1720b, 1720c, 1720d, 1720e, etc. may be responsible for the maintenance and updating of a database 1730 or other storage element, such as a database or memory 1730 for storing data processed or saved according to the invention. Thus, the present invention can be utilized in a computer network environment having client computers 1720a, 1720b, 1720c, 1720d, 1720e, etc. that can access and interact with a computer network/bus 1740 and server computers 1710a, 1710b, etc. that may interact with client computers 1720a, 1720b, 1720c, 1720d, 1720e, etc. and other like devices, and databases 1730.

### Exemplary Computing Device

As mentioned, the invention applies to any device wherein it may be desirable to automatically update schema maps based on schema changes. It should be understood, therefore, that handheld, portable and other computing devices and computing objects of all kinds are contemplated for use in connection with the present invention, i.e., anywhere that a device may include schema maps that map between schemas or otherwise receives, processes or stores data. Accordingly, the below general purpose remote computer described below in FIG. 18 is but one example, and the present invention may be implemented with any client having network/bus interoperability and interaction. Thus, the present invention may be implemented in an environment of networked hosted services in which very little or minimal client resources are implicated, e.g., a networked environment in which the client device serves merely as an interface to the network/bus, such as an object placed in an appliance.

Although not required, the invention can partly be implemented via an operating system, for use by a developer of services for a device or object, and/or included within application software that operates in connection with the component(s) of the invention. Software may be described in the general context of computer-executable instructions, such as program modules, being executed by one or more computers, such as client workstations, servers or other devices. Those skilled in the art will appreciate that the invention may be practiced with other computer system configurations and protocols.

FIG. 18 thus illustrates an example of a suitable computing system environment 1800a in which the invention may be implemented, although as made clear above, the computing system environment 1800a is only one example of a suitable computing environment for a media device and is not intended to suggest any limitation as to the scope of use or functionality of the invention. Neither should the computing environment 1800a be interpreted as having any dependency or requirement relating to any one or combination of components illustrated in the exemplary operating environment 1800a.

With reference to FIG. 18, an exemplary remote device for implementing the invention includes a general purpose computing device in the form of a computer 1810a. Components of computer 1810a may include, but are not limited to, a processing unit 1820a, a system memory 1830a, and a system bus 1821a that couples various system components including the system memory to the processing unit 1820a. The system bus 1821a may be any of several types of bus structures including a memory bus or memory controller, a peripheral bus, and a local bus using any of a variety of bus architectures.

Computer 1810a typically includes a variety of computer readable media. Computer readable media can be any available media that can be accessed by computer 1810a. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 1810a. Communication media typically embodies computer readable instructions, data structures, program modules or other data in a modulated data signal such as a carrier wave or other transport mechanism and includes any information delivery media.

The system memory 1830a may include computer storage media in the form of volatile and/or nonvolatile memory such as read only memory (ROM) and/or random access memory (RAM). A basic input/output system (BIOS), containing the basic routines that help to transfer information between elements within computer 1810a, such as during start-up, may be stored in memory 1830a. Memory 1830a typically also contains data and/or program modules that are immediately accessible to and/or presently being operated on by processing unit 1820a. By way of example, and not limitation, memory 1830a may also include an operating system, application programs, other program modules, and program data.

The computer 1810a may also include other removable/non-removable, volatile/nonvolatile computer storage media. For example, computer 1810a could include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive is typically connected to the system bus 1821a through a non-removable memory interface such as an interface, and a magnetic disk drive or optical disk drive is typically connected to the system bus 1821a by a removable memory interface, such as an interface.

A user may enter commands and information into the computer 1810a through input devices such as a keyboard and pointing device, commonly referred to as a mouse, trackball or touch pad. Other input devices may include a microphone, joystick, game pad, satellite dish, scanner, or the like. These and other input devices are often connected to the processing unit 1820a through user input 1840a and associated interface(s) that are coupled to the system bus 1821a, but may be connected by other interface and bus structures, such as a parallel port, game port or a universal serial bus (USB). A graphics subsystem may also be connected to the system bus 1821a. A monitor or other type of display device is also connected to the system bus 1821a via an interface, such as output interface 1850a, which may in turn communicate with video memory. In addition to a monitor, computers may also include other peripheral output devices such as speakers and a printer, which may be connected through output interface 1850a.

The computer 1810a may operate in a networked or distributed environment using logical connections to one or more other remote computers, such as remote computer 1870a, which may in turn have media capabilities different from device 1810a. The remote computer 1870a may be a personal computer, a server, a router, a network PC, a peer device or other common network node, or any other remote media consumption or transmission device, and may include any or all of the elements described above relative to the computer 1810a. The logical connections depicted in FIG. 18 include a network 1871a, such local area network (LAN) or a wide area network (WAN), but may also include other networks/buses. Such networking environments are commonplace in homes, offices, enterprise-wide computer networks, intranets and the Internet.

When used in a LAN networking environment, the computer 1810a is connected to the LAN 1871a through a network interface or adapter. When used in a WAN networking environment, the computer 1810a typically includes a communications component, such as a modem, or other means for establishing communications over the WAN, such as the Internet. A communications component, such as a modem, which may be internal or external, may be connected to the system bus 1821a via the user input interface of input 1840a, or other appropriate mechanism. In a networked environment, program modules depicted relative to the computer 1810a, or portions thereof, may be stored in a remote memory storage device. It will be appreciated that the network connections shown and described are exemplary and other means of establishing a communications link between the computers may be used.

### Exemplary Distributed Computing Architectures

Various distributed computing frameworks have been and are being developed in light of the convergence of personal computing and the Internet. Individuals and business users alike are provided with a seamlessly interoperable and Web-enabled interface for applications and computing devices, making computing activities increasingly Web browser or network-oriented.

For example, MICROSOFT®'s managed code platform, i.e., .NET, includes servers, building-block services, such as Web-based data storage and downloadable device software. Generally speaking, the .NET platform provides (1) the ability to make the entire range of computing devices work together and to have user information automatically updated and synchronized on all of them, (2) increased interactive capability for Web pages, enabled by greater use of XML rather than HTML, (3) online services that feature customized access and delivery of products and services to the user from a central starting point for the management of various applications, such as e-mail, for example, or software, such as Office .NET, (4) centralized data storage, which increases efficiency and ease of access to information, as well as synchronization of information among users and devices, (5) the ability to integrate various communications media, such as e-mail, faxes, and telephones, (6) for developers, the ability to create reusable modules, thereby increasing productivity and reducing the number of programming errors and (7) many other cross-platform and language integration features as well.

While some exemplary embodiments herein are described in connection with software, such as an application programming interface (API), residing on a computing device, one or more portions of the invention may also be implemented via an operating system, or a “middle man” object, a control object, hardware, firmware, intermediate language instructions or objects, etc., such that the methods for automatically updating schema maps based on schema changes in accordance with the invention may be included in, supported in or accessed via all of the languages and services enabled by managed code, such as .NET code, and in other distributed computing frameworks as well.

There are thus multiple ways of implementing the present invention, e.g., an appropriate API, tool kit, driver code, operating system, control, standalone or downloadable software object, etc. which enables applications and services to use the systems and methods for automatically updating schema maps in accordance with the invention. The invention contemplates the use of the invention from the standpoint of an API (or other software object), as well as from a software or hardware object that receives schema changes that occur in a computing system implicating the systems and methods for automatically updating schema maps in accordance with the invention. Thus, various implementations of the invention described herein may have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned above, while exemplary embodiments of the present invention have been described in connection with various computing devices and network architectures, the underlying concepts may be applied to any computing device or system in which it is desirable to automatically update schema maps based on schema changes. For instance, the automatic updating of schema maps in accordance with the invention may be applied to the operating system of a computing device, provided as a separate object on the device, as part of another object, as a reusable control, as a downloadable object from a server, as a “middle man” between a device or object and the network, as a distributed object, as hardware, in memory, a combination of any of the foregoing, etc. While exemplary programming languages, names and examples are chosen herein as representative of various choices, these languages, names and examples are not intended to be limiting. One of ordinary skill in the art will appreciate that there are numerous ways of providing object code and nomenclature that achieves the same, similar or equivalent functionality achieved by the various embodiments of the invention.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, and at least one output device.

One or more programs that may implement or utilize the automatic updating of schema maps in accordance with the invention, e.g., through the use of a data processing API, reusable controls, or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, etc., the machine becomes an apparatus for practicing the invention. When implemented on a general-purpose processor, the program code combines with the processor to provide a unique apparatus that operates to invoke the functionality of the present invention. Additionally, any storage techniques used in connection with the present invention may invariably be a combination of hardware and software.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The term “article of manufacture” (or alternatively, “computer program product”) where used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the disclosed subject matter will be better appreciated with reference to the flowcharts of FIGS. 3, 4 and 5. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

Furthermore, as will be appreciated various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

While the present invention has been described in connection with the preferred embodiments of the various figures, it is to be understood that other similar embodiments may be used or modifications and additions may be made to the described embodiment for performing the same function of the present invention without deviating therefrom. For example, while exemplary network environments of the invention are described in the context of a networked environment, such as a peer to peer networked environment, one skilled in the art will recognize that the present invention is not limited thereto, and that the methods, as described in the present application may apply to any computing device or environment, such as a gaming console, handheld computer, portable computer, etc., whether wired or wireless, and may be applied to any number of such computing devices connected via a communications network, and interacting across the network. Furthermore, it should be emphasized that a variety of computer platforms, including handheld device operating systems and other application specific operating systems are contemplated, especially as the number of wireless networked devices continues to proliferate.

While exemplary embodiments refer to utilizing the present invention in the context of particular programming language constructs, the invention is not so limited, but rather may be implemented in any language to provide methods for automatically updating schema maps in accordance with the invention. Still further, the present invention may be implemented in or across a plurality of processing chips or devices, and storage may similarly be effected across a plurality of devices. Therefore, the present invention should not be limited to any single embodiment, but rather should be construed in breadth and scope in accordance with the appended claims.

What is claimed is:

1. A method, comprising:
receiving information representative of at least one change to a schema of a plurality of schema in a computing system; and
in response to receiving the information, automatically updating at least one dependent entity of a plurality of dependent entities in the computing system that depend from the at least one change to the schema, each of which plurality of dependent entities is based on at least one schema of the plurality of schema.

2. The method of claim 1, wherein the at least one dependent entity of the plurality of dependent entities includes at least one map of a plurality of maps, each of which interrelates at least two schema of the plurality of schema.

3. The method of claim 2, wherein said updating includes storing versioning information for the at least one map.

4. The method of claim 3, further including:
displaying a map of the at least one map and based on the versioning information, displaying changes made to the map from the automatically updating step.

5. The method of claim 1, wherein said updating includes updating interrelationships between structural elements of at least two schema of the plurality of schema.

6. The method of claim 1, further including:
editing a schema of the plurality of schema via an editing tool; and
wherein said receiving includes receiving an output of said editing indicative of any changes effected during said editing.

7. The method of claim 1, wherein said receiving includes receiving information representative of at least one change to at least one Electronic Data Interchange (EDI) transaction set definition (TSD) of an EDI messaging system.

8. The method of claim 1, wherein said receiving includes receiving information representative of at least one change to at least one relational database table structure definition of a relational database system.

9. The method of claim 1, wherein said receiving includes receiving information representative of at least one change to at least one RosettaNet schema definition of a RosettaNet communications system.

10. A computer readable medium comprising computer executable instructions for performing the method of claim 1.

11. A server object for interfacing with at least one data store that stores a plurality of schema as a plurality of schema elements and a plurality of schema maps that define mappings between the plurality of schema elements of different schema of the plurality of schema, including:
a schema map update component that receives a representation of at least one schema change made to at least one schema element of at least one schema of the plurality of schema from the at least one data store, and automatically updates at least one schema map that is dependent upon the at least one schema change; and
an interface component for interfacing to the at least one data store on behalf of the schema map update component to receive said representation of the at least one schema change and to store said updated at least one schema map.

12. The server object of claim 11, wherein the schema map update component determines versioning information for the at least one map, wherein the versioning information enables differences between different versions of a map to be determined.

13. The server object of claim 11, further including:
a user interface component for displaying at least one schema of the plurality of schema.

14. The server object of claim 13, wherein said user interface component is further for editing at least one schema of the plurality of schema to generate said at least one schema change.

15. The server object of claim 11, further including:
a user interface component for displaying the updated at least one schema map.

16. A method for use in an electronic data interchange (EDI) communications system, comprising:
receiving change data representing at least one change to at least one transaction set definition (TSD) of the EDI system; and
in response to receiving the change data, automatically updating mappings represented by at least one map that is based on the at least one changed TSD, wherein the mappings interrelate EDI elements of at least two TSDs.

17. The method of claim 16, wherein said updating includes storing versioning data for the at least one map wherein the versioning data represents differences between different versions of a map after said updating.

18. The method of claim 17, further including:
displaying a map of the at least one map and based on the versioning information, displaying changes made to the map from the automatically updating step.

19. The method of claim 16, further including:
editing a TSD of the at least one TSD via an editing tool; and
wherein said receiving includes receiving change data representing changes made to the TSD during said editing.

20. The method of claim 16, further including:
determining whether any maps are dependent on the at least one changed TSD, and if so, performing said automatic updating step.
